(19) United States
(12) Patent Application Publication
(10) Pub. No.: US 2014/0302888 A1
(43) Pub. Date: Oct. 9, 2014

(54) INTEGRATED RADIO COMMUNICATION MODULE

(71) Applicant: Sierra Wireless, Inc., Richmond (CA)

(72) Inventors: Ashish SYAL, Vancouver (CA); Gustav Gerald VOS, Surrey (CA); Jean-Pierre MAUCLERC, Montrouge (FR)

(73) Assignee: Sierra Wireless, Inc., Richmond (CA)

(21) Appl. No.: 14/249,077

(22) Filed: Apr. 9, 2014

Related U.S. Application Data
(60) Provisional application No. 61/810,122, filed on Apr. 9, 2013.

(51) Int. Cl. H04B 1/40

(52) U.S. Cl. CPC H04B 1/401
USPC 455/552.1

(57) ABSTRACT

A compact, integrated wireless communication module includes a data interface, baseband electronics section, radiofrequency electronics section and antenna connector. The module may be operable as a stand-alone wireless communication device for incorporation into larger host devices. The module is certifiable or pre-certified as a stand-alone wireless device in accordance with a given set of certification processes.

### CROSS-REFERENCE TO RELATED APPLICATIONS

This application claims the benefit and priority of U.S. Provisional Application 61/810,122, filed Apr. 9, 2013. The foregoing application is incorporated by reference herein in its entirety.

### FIELD OF THE TECHNOLOGY

The present technology pertains in general to wireless communication electronics and in particular to an integrated radio communication module.

### BACKGROUND

Various radio communication modules are commercially available which can be used to connect with mobile networks, for example built around existing standards such as GSM, GPRS, WCDMA, UMTS, LTE, EDGE, CDMA2000, and the like. Such modules may be small in size, for example fitting inside a small semiconductor package which may be soldered to a printed circuit board or inserted into a slot or socket of an electronic device. Examples of such modules can be found within the AirPrime™ line of wireless modules offered by Siena Wireless™.

Typically, these modules require the addition of a SIM card and an antenna connector for facilitating connection to an external antenna, which is either built into or connected to the host machine. The modules also require an internal signal connection to other electronics of the host machine in order to provide data communication. This additional system integration means that the modules as they stand cannot be fully tested and certified for their end use. Certification is required by national licensing authorities such as the Federal Communications Commission (FCC) and Industry Canada. Certification may also be required by individual mobile network operators such as AT&T or Rogers Communications.

In many instances, certification tests are required to be performed on the complete product, which includes the module as well as the device, antenna and other components such as the SIM card, housing, and associated electronics. Thus, testing of the radio module on its own may not be sufficient to satisfy certain regulators. Regulatory testing and approval is a significant cost and delay factor in providing a product containing capabilities offered by a wireless module.

The FCC offers modular approval and limited modular approval processes by which a radio module may be approved separate from its intended host device, under certain conditions. However, mobile network operators and other regulatory agencies may not offer the same type of process. Furthermore, such modular approvals may be subject to different conditions from approvals for non-modular or stand-alone devices.

Therefore there is a need for an integrated radio communication module that is not subject to one or more limitations of the prior art.

This background information is provided for the purpose of making known information believed by the applicant to be of possible relevance to the present technology. No admission is necessarily intended, nor should be construed, that any of the preceding information constitutes prior art against the present technology.

### SUMMARY OF THE TECHNOLOGY

An object of the present technology is to provide an integrated radio communication module. In accordance with an aspect of the present technology, there is provided an integrated wireless communication module configured to be coupled to a host device, the integrated wireless communication module comprising: a data interface; a baseband electronics portion operatively coupled to the data interface; a radiofrequency electronics portion operatively coupled to the baseband electronics portion, the baseband electronics portion and the radiofrequency electronics portion facilitating operation of the wireless communication module as a wireless transmitter, receiver or transceiver in accordance with at least one wireless communication protocol; and an antenna connector operatively coupled to the radiofrequency electronics portion; wherein the integrated wireless communication module is configured to achieve certification as a stand-alone device with respect to one or more predetermined sets of certification criteria.

In accordance with another aspect of the present technology, there is provided a method of manufacturing an integrated wireless communication module configured to be coupled to a host device, the method comprising: providing a baseband electronics portion operatively coupled to a data interface; providing a radiofrequency electronics portion operatively coupled to the baseband electronics portion, wherein the baseband electronics portion and the radiofrequency electronics portion facilitate operation of the wireless communication module as a wireless transmitter, receiver or transceiver in accordance with at least one wireless communication protocol; providing an antenna connector operatively coupled to the radiofrequency electronics portion; and configuring the integrated wireless communication module to achieve certification as a stand-alone device with respect to one or more predetermined sets of certification criteria.

### BRIEF DESCRIPTION OF THE FIGURES

These and other features of the technology will become more apparent in the following detailed description in which reference is made to the appended drawings.

FIG. 1 illustrates a cross-sectional view of aspects of a wireless communication module provided in accordance with embodiments of the present technology.

FIG. 2 illustrates a cross-sectional view of aspects of a wireless communication module provided in accordance with other embodiments of the present technology.

FIGS. 3a and 3b illustrate exploded perspective views of aspects of a wireless communication module provided in accordance with other embodiments of the present technology.

FIGS. 4a and 4b illustrate exploded perspective views of aspects of a wireless communication module provided in accordance with other embodiments of the present technology.

FIGS. 5a and 5b illustrate exploded perspective views of aspects of a wireless communication module provided in accordance with other embodiments of the present technology.

FIGS. 6a and 6b illustrate stackable components of a wireless communication module provided in accordance with embodiments of the present technology.

FIG. 7 illustrates stackable components of a wireless communication module provided in accordance with other embodiments of the present technology.

FIG. 8 illustrates an unstacked arrangement of components of a wireless communication module provided in accordance with other embodiments of the present technology.

FIG. 9 illustrates, in cross section, a system of stacked printed circuit modules defining cavities therein, in accordance with one embodiment of the invention.

FIG. 10 illustrates, in cross section, a system of stacked printed circuit modules defining cavities therein, in accordance with one embodiment of the invention.

FIG. 11a illustrates a socket for coupling to a printed circuit board, and configured to receive stacked electronics modules therein, in accordance with embodiments of the invention.

FIG. 11b illustrates a portion of a stacked connector provided within the socket of FIG. 11a and configured for electrically coupling to the stacked electronics modules.

FIG. 11c illustrates a coupling between pins of the stacked electronics modules and the stacked connector of FIG. 11a.

FIG. 12 illustrates a socket for coupling to a printed circuit board, and configured to receive stacked electronics modules therein, in accordance with another embodiment of the invention.

FIG. 13 illustrates, in cross section, a stackable, encapsulated printed circuit assembly provided in accordance with another embodiment of the present invention.

FIG. 14 illustrates a stacked arrangement of plural encapsulated printed circuit assemblies, in accordance with an embodiment of the present invention.

FIG. 15 illustrates a stacked arrangement of plural encapsulated printed circuit assemblies, in accordance with another embodiment of the present invention.

FIGS. 16a to 16c illustrate exploded, top and perspective views of a wireless communication module provided in accordance with embodiments of the present technology.

### DETAILED DESCRIPTION OF THE TECHNOLOGY

### Definitions

The term “Printed Circuit Board” or “PCB” refers to a single-sided, double-sided, or multilayer printed circuit board to which components may be attached, for example by soldering.

The term “Printed Circuit Assembly” or “PCA” refers to a PCB along with electronics components, such as chips, and/or other structural components such as frames or spacers attached thereto.

The term “Printed Circuit Module” or “PCM” is used generically to refer to either a PCB or a PCA. A PCM may or may not include an encapsulant.

The term “Chip” refers to a packaged electronic device, such as a semiconductor device, integrated circuit, set of semiconductor devices or integrated circuits, or the like. The package may be a plastic chip carrier, ceramic chip carrier, or other suitable package. The package typically comprises one or more electrical connectors such as pins, pads, leads, apertures, vias, solder balls, solder bumps, or the like, operatively coupled to the electronic device therein. Standard chip carriers include BGAs, LGAs, PLCCs, DIPs, SOICs, and numerous other chip carriers as would be readily understood by a worker skilled in the art.

The term “encapsulant” or “conformal encapsulant” refers to a generally insulating material which is applied to a PCA and forming around the PCA components in a conformal manner. For example, the encapsulant may be applied as a fluid or spray-on coating, which contacts the PCA components and cures into a solid encapsulant with a perimeter. The perimeter may be formed in a desired manner, for example to form a cube, rectangular prism, or other shape. Encapsulants applied to PCAs are generally electrically insulating, and may also be electromagnetically insulating. Encapsulants may be provided having desired thermal conduction properties, predetermined physical properties such as strength, plasticity, elasticity, and the like.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this technology belongs.

Aspects of the present technology generally relate to an integrated wireless communication module. The module may be generally compact and configured to be coupled to a host device, for example housed within the cavity of a mobile device. However, the module may also be capable of operating for communication purposes as a substantially stand-alone device, given a source of power, user or data interface, and antenna. Communication may comprise cellular communication. The integrated wireless communication module generally comprises a data interface; a baseband electronics portion; a radiofrequency electronics portion; and an antenna connector. The data interface may comprise a plug-in connector or other interface means. The baseband electronics portion is operatively coupled to the data interface. The radiofrequency electronics portion is operatively coupled to the baseband electronics portion. The baseband electronics portion and the radiofrequency electronics portion together facilitate operation of the wireless communication module as a wireless transmitter and/or receiver in accordance with at least one wireless communication protocol. The antenna connector is operatively coupled to the radiofrequency electronics section and can be configured for removable coupling with one or more antennas. The integrated wireless communication module is configured to achieve certification as a stand-alone device with respect to one or more predetermined sets of certification criteria. This may be in part by virtue of the module's capability to operate as a substantially stand-alone device.

The wireless communication module may further optionally comprise a removable identity module connector, such as a micro SIM card holder. The wireless communication module may further optionally comprise a removable antenna and/or a removable antenna test connector.

In various embodiments, the module is operable, certifiable and/or certified as a stand-alone wireless device in accordance with a predetermined set of certification processes. The set of processes may comprise national or regional certification processes such as FCC processes, mobile network operator (MNO) certification processes, standards body certification processes, and the like.

The wireless communication module may be configured to meet all the criteria of a stand-alone wireless communication device, as defined by at least one authority under which the module is to be potentially certified. This may ease requirements for systems integration as the wireless communication module can be incorporated into a wider range of host devices (or even used on its own) without requiring further attention to certification issues by the systems integrators. This additional flexibility may provide for more efficient device supply chains.

In some embodiments, the wireless communication module is configured to meet all the criteria of a stand-alone wireless communication device as defined by at least two authorities under which the module is to be potentially certified. This may comprise identifying and complying with the strictest criteria of the at least two authorities. If the criteria for a first authority are stricter than those of a second authority in a first set of aspects, and the criteria for the second authority are stricter than those of the first authority in a second set of aspects, then the wireless communication module may be configured to satisfy both the first set of aspects and the second set of aspects, thereby satisfying both sets of criteria.

### Interface Components

Various embodiments of the present technology comprise interface components such as a data interface, antenna connector, and removable identity module connector, as described in further detail below.

In some embodiments, the data interface comprises a suitably compact plug-in electrical connector, such as a female micro-USB™ connector or proprietary connector. Communication with the data interface may follow a predetermined protocol, such as a USB™ protocol, I²C protocol, or the like. In some embodiments, the data interface is capable of functioning as a user interface.

In some embodiments, the baseband electronics section comprises a removable identity module plug-in connector, such as a micro Subscriber Identity Module (SIM) card holder. In some embodiments, the baseband module may further comprise a removable or non-removable identity module, such as a SIM, micro SIM card, or the like. As will be readily understood by a worker skilled in the art, a SIM or other type of identity module may be required for communication with certain types of wireless networks.

The antenna connector may be a micro antenna connector, such as a snap-on antenna connector rated for a limited number of insertion/removal cycles. The antenna connector may be provided on a top surface of the module, for example. An example of a micro antenna connector is a miniature coaxial RF connector such as the U.FL surface-mount connector manufactured by Hirose Electric Group, or the IPX microminiature RF coaxial connector available from Lighthorse Technologies Inc.

In some embodiments, a test connector module may be provided which attaches to an antenna connection point as a snap-on part similar to the snap-on antenna and which is used for test purposes. In this case the antenna connector may comprise a conductive pad. The test connector module may be configured to provide a connection between the antenna connector and/or to standard test equipment. For example, the test connector module may comprise a micro antenna connector which mates to the micro antenna connector of the wireless communication module, and a coaxial connector which is configured to mate with standard RF test equipment.

In various embodiments, a snap-on antenna connector or snap-on test connector module may incorporate a spring connection which presses on to the antenna connection pad when attached.

In some embodiments, the wireless communication module further comprises an alternative antenna connection point. For example, whereas the antenna connector may be located on a top surface of the module, the alternative antenna connection point may be located on a bottom surface or along an edge of the bottom surface. In some embodiments, the alternative antenna connection point may comprise solderable pins, leads, solder balls, or the like, provided in accordance with a standard chip carrier. In some embodiments, the alternative antenna connection point is provided or enabled only if its presence does not inhibit success of one or more predetermined sets of certification processes. In some embodiments, the alternative antenna connection point is disabled, for example by irreversible internal physical or logical disconnection of an internal electrical connection line routed to the alternative antenna connection point, if the antenna's presence would otherwise inhibit success according to a desired set of certification processes. Such disabling may also be reversible, if allowable by certification authorities. In one embodiment, the connection line may comprise a fuse for this purpose.

### Antenna

In some embodiments, the module further comprises an antenna removably coupled to the antenna connector. The antenna may be pre-configured for operation with the module, for example by tuning the antenna to the appropriate operating frequency of the RF electronics section, and by matching the antenna impedance with the RF electronics and transmission line integrated into the module, to which the antenna directly couples. The antenna may be generally compact, for example having all of its dimensions smaller than or equal to corresponding dimensions of the module. The removable nature of the antenna from the antenna coupler may facilitate certification tests which require removal of the antenna and coupling of test equipment to the antenna connector.

For example, antennas with adequate performance in the 1800 MHz band may be provided which are as small as for example 1 mm by 2 mm. Such antennas may be bought from a third party or designed along with the module. Such antennas may be particularly appropriate when the wireless communication module is to be located within a larger device whose packaging does not unacceptably impede communication when the antenna is placed inside.

### Operational Components

A wireless communication module according to the present technology comprises operational components such as a baseband electronics section and a radiofrequency (RF) electronics section.

In some embodiments, the baseband electronics section comprises separate components from the RF electronics section, and the two sections are operatively coupled. Operative coupling may be via electrically conductive signal carriers such as wires, mating electrical connectors, conductive traces, component leads, solder joints, pins, pads, electrically plated holes or vias, or the like, or a combination thereof. Alternative operative coupling means may be used, such as optical coupling, inductive coupling, or short-range RF coupling, as would be readily understood by a worker skilled in the art.

The baseband electronics section is generally configured to provide an interface between the user or data interface and the RF electronics section, along with management of associated controls and other operational aspects. The baseband electronics section may comprise one or more microcontrollers, volatile and/or non-volatile memory, baseband logic and electronics, identity modules, codecs, UARTs, firmware, power management unit, or the like, or a combination thereof, as would be readily understood by a worker skilled in the art.

The RF electronics section is generally configured to provide an interface between the baseband electronics section and the antennas, along with management of associated controls and other operational aspects. The RF electronics section may comprise a power amplifier section, capacitor section, radio frequency integrated circuit section, RF transmission lines and impedance control means, RF front end and/or switches, or the like, or a combination thereof, as would be readily understood by a worker skilled in the art.

### Physical Configuration

In some embodiments, one or more components of the module are provided in a stacked configuration. For example, the antenna connector and micro SIM card slot may be located on top of the module. As another example, the baseband electronics section is located underneath the RF electronics section. Different stacked components may be provided as different printed circuit assemblies, chip carriers, encapsulated semiconductor packages or printed circuit assemblies, or the like. In some embodiments, the various stackable components have a common shape or fit within a common footprint. In some embodiments, the various stackable components are interchangeable. In some embodiments, assembled stacks of components are interchangeable.

In some embodiments, an encapsulant may be conformally provided over the module, various components thereof, or both. One or more channels may be formed through the encapsulant, with each of the one or more channels configured to electrically couple a predetermined electrical element which is interior to the encapsulant with a predetermined location on a surface of the encapsulant. The channels may be formed using a laser to cut through the encapsulant, with the channels subsequently made conductive by depositing metal therein. Each channel may terminate, for example, at a pad of a PCB which has been so encapsulated.

For example, if the pad is a ground pad, such a conductive channel formed through the encapsulant may electrically couple the ground pad to a thin layer of metal formed on top of the encapsulant, so as to form a Faraday shield. As another example, if the pad is associated with a signal line or power line, the conductive channel may electrically couple the pad to a signal trace, pad and/or connector located on the outside surface of the encapsulant. Signal traces and/or pads may be formed, for example, by providing and subsequently etching a conductive layer on the outer surface of the encapsulant.

In some embodiments, an encapsulant outer surface may comprise an antenna connector, a SIM card connector, a user and/or data interface connector, or a combination thereof. Different connected or disconnected encapsulant outer surfaces may comprise different connectors. In some embodiments, an alternate antenna connector, an alternate SIM card connector, an alternate user and/or data interface connector, or a combination thereof may also be provided. In some embodiments, the encapsulant having the above connectors may be an encapsulant formed over the entire wireless communication module.

In some embodiments, the encapsulant may be shaped to provide mating features between modules. Mating features may facilitate alignment and/or mechanical interconnection, and may include tongue and groove features, protrusions which snap into mating recesses, shaped surfaces which prevent mis-orientation when mating modules, or the like.

### Interchangeable Family of Modules

In some embodiments, a family of wireless modules with the same physical characteristics but different functional characteristics may be provided. For example, each wireless module may have substantially the same physical dimensions, power requirements, operating condition tolerances, and physical and electrical connection layouts. Each wireless module of a family may comprise a substantially standardized interface, a substantially standardized interface protocol, a substantially standardized command set, substantially standardized power requirements, or a combination thereof. Thus, each wireless module of the family may be easily interchanged with another wireless module from the same family. In some embodiments, different wireless modules of the family may include a different combination of one or more air interfaces, such as 2G (GSM/GPRS), 3G (WCDMA) or 4G (LTE) air interfaces. In some embodiments, each wireless module has a single air interface.

In some embodiments, different members of a family may operate in different radio bands corresponding to different standards or conventions used in different geographic locations. Thus, a single product may be customized for use in a particular geographic region by incorporating the appropriate module from a family.

In some embodiments the module is soldered to a host PCB. In some embodiments the module is fitted inside a socket which has substantially the same footprint as the module. This configuration can allow a product to be equipped with a socket so that it may be configured after assembly as the socket can allow for insertion of a specific module which can be selected based on parameters including wireless system, frequency band, market or the like, wherein these parameters are determined after assembly. This configuration can provide flexibility when there are relatively few products required of each type. Alternatively, if there is a higher volume of products requiring one particular module, that module may be directly soldered down for likely reduced manufacturing costs.

In some embodiments, within the region of the placement of the module, a plurality of solder pads can be provided, wherein these solder pads can be configured to provide heat dissipation from the module to the PCB.

In some embodiments, wherein the module is positioned relative to the PCB using a socket, a lid positioned over the module can include biasing tabs, for example spring tabs, that can be configured to bear and make contact with the surface of the module, wherein these biasing tabs can provide a means for heat transfer and/or heat dissipation from the module to the lid.

The technology will now be described with reference to specific examples. It will be understood that the following examples are intended to describe embodiments of the technology and are not intended to limit the technology in any way.

### EXAMPLES

### Example 1

In some embodiments, a compact integrated wireless communication module is implemented as follows. A wireless chip module such as the AirPrime™ AR3550 offered by Siena Wireless™ is mounted onto a small host printed circuit board (PCB) together with an identity module holder such as a micro SIM card holder, a micro antenna connector and a user or data interface connector such as a micro USB™ connector. Additionally or alternatively, the wireless chip module may comprise an embedded SIM. Such wireless chip modules may not be completely integrated or operable or certifiable as a stand-alone wireless device. The wireless chip module may comprise various inputs and outputs provided for example via pins or leads of its host chip carrier. Inputs may facilitate powering of the module as well as communication with the module, for example via a standardized serial or parallel communication interface. An input, output, or combination input/output may facilitate connection to an RF transmission line and associated antenna. The wireless chip module may be soldered to the PCB or mounted within an appropriate socket which is soldered to the PCB. In some embodiments, the wireless chip module has horizontal dimensions of about 20 mm by 22 mm, and the host PCB has horizontal dimensions of about 35 mm by 35 mm. In some embodiments, a socket can be configured such that two modules can be stacked therein, wherein the socket provides the desired connectivity for the modules.

The wireless chip module may comprise various functional components, such as a microprocessor, microcontroller, memory, UART, RF transceiver, power amplifier, serial interface, and the like. These various functional components are associated with the baseband electronics section and RF electronics section.

In some embodiments, the wireless communication module comprises the host PCB. The host PCB may comprise the user or data interface connector soldered thereto, along with a connector for connecting to an external power source, if required. The identity module holder may be mounted on the host printed circuit board or in a stacked configuration, for example mounted on top of the wireless chip module. Similarly, the micro antenna connector may be mounted on the host printed circuit board or in a stacked configuration, for example on top of the wireless chip module or identity module holder.

In some embodiments, on the condition that the success of one or more predetermined sets of certification processes is not inhibited, the bottom side of the host PCB may comprise alternative, solderable, antenna and user or data interface connection points, such as pads coupled to circuit board traces or vias, which are in turn connected to pins of the wireless chip module. Power connectors may similarly be provided on the bottom of the PCB. A systems integrator may thus use these alternative connection points by soldering the PCB to their own circuit board, without the need to use the micro antenna connector and user or data interface connector. This may allow the module to be used in a wider range of scenarios. Furthermore, the micro antenna connector and user or data interface connector on top of the PCB may render the module certifiable, while the alternative connection points on the bottom side of the host PCB may facilitate a mode of integration that is preferred by some buyers, such as automotive manufacturers and system integrators using automated manufacturing methods. The compact size of the module facilitates its integration into host products such as mobile computing devices, hand-held consumer electronics, larger printed circuit boards, and the like.

### Example 2

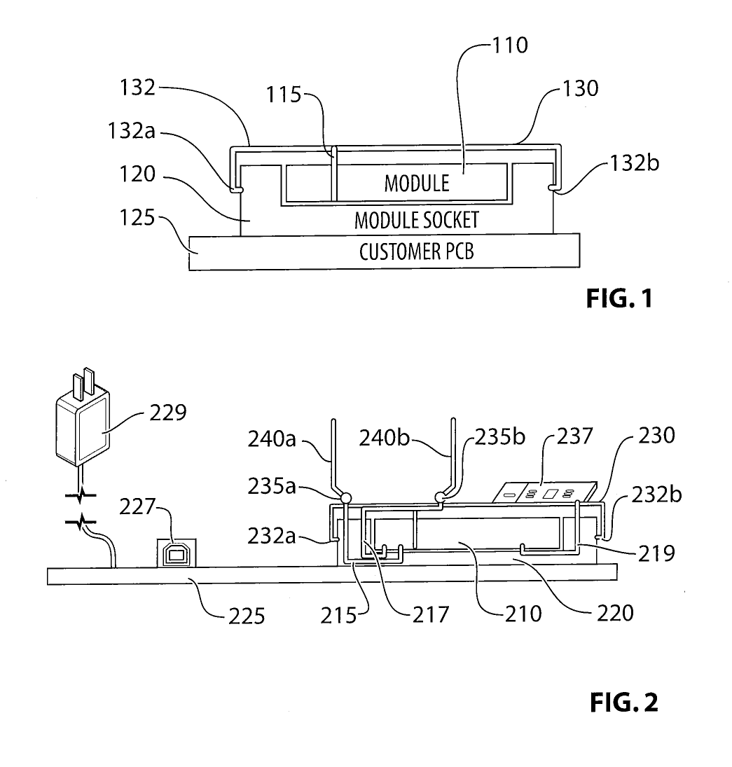

FIG. 1 illustrates, in cross section, aspects of a wireless communication module provided in accordance with an embodiment of the present technology. An encapsulated or non-encapsulated chip module 110 is provided which fits into a socket 120 mounted to a PCB 125. The PCB may be one that is associated with a device into which the wireless communication module is inserted, or a small host PCB, for example about the same size as the socket, which forms part of the wireless communication module and can be attached within the device. The chip module 110 comprises the baseband electronics and radiofrequency electronics, as well as at least part of an antenna connector component 115. The antenna connector component may comprise an RF transmission line, such as a coaxial cable, microstrip or stripline. The chip module 110 further comprises electrical connectors, which are configured to mate with corresponding electrical connectors of the socket 120. One or both of the electrical connectors of the chip module and the socket may be spring connectors, for example.

The antenna connector component 115 may terminate in a micro antenna connector or conductive end for mating with the antenna 130. As illustrated, the antenna 130 can be formed on an antenna lid 132, which can be mechanically connected to the outside edges of the socket 120. The antenna 130 may be a resilient body which is configured for gripping engagement of the socket 120. Optionally, the socket 120 may include grooves or divots for accommodating the antenna lid edges 132a, 132b. In some embodiments, the antenna connector component terminates in an electrical connector which is configured for electrical connection to the antenna at a predetermined location. The electrical connector may be mounted on the side of the socket 120, for example. One or both of the antenna connector component's electrical connectors and a corresponding connection point on the antenna may be spring connectors. In some embodiments, the mechanical connection of the top plate to the socket results in pressure of the antenna 130 against the end of the antenna connector component 115, which facilitates electrical connection of the antenna 130 to the antenna connector component 115.

### Example 3

FIG. 2 illustrates, in cross section, aspects of a wireless communication module provided in accordance with another embodiment of the present technology. As with FIG. 1, an encapsulated or non-encapsulated chip module 210 is provided which fits into a socket 220 mounted to a PCB 225. The PCB 225 may comprise a USB connector 227 and a power connector 229, for example as electrical-mechanical connector components mounted to the PCB. As illustrated, the chip module 210 comprises a pair of antenna connector components 215 and 217, although only a single antenna connector component may be provided in some embodiments. Each antenna connector component comprises an RF transmission line, such as a coaxial cable, microstrip or stripline.

The antenna connector components 215 and 217 may terminate in a micro antenna connector or other electrical connector for mating with a top plate 230. As illustrated, the top plate 230 is substantially C-shaped and has edges 232a, 232b which are configured to mechanically connect to the outside edges of the socket 220. The top plate 230 may be a resilient body which is configured for gripping engagement of the socket 220. Optionally, the socket 220 may include grooves or divots for accommodating the edges 232a, 232b. In some embodiments, the mechanical connection of the top plate to the socket results in a pressure of the top plate 230 against the end of the antenna connector components 215, 217, which facilitates electrical connection of the top plate 230 to the antenna connector components 215, 217. In some embodiments, the antenna connectors 215, 217 can be formed as a portion of the top plate 230, wherein these antenna connectors can be positioned and configured to press upon and make operative contact with the respective contacts on the top of the socket 220.

A SIM connector component 219 may also be provided, which comprises one or more baseband signal transmission lines, such as conductive wires, traces, electrically plated channels, or the like.

The SIM connector component 219, the antenna connector components 215, 217, or both may be routed through the socket 220 or a PCB upon which the socket is mounted, and may terminate with electrical connectors which are configured to mate with corresponding electrical connectors of the top plate 230. The electrical connectors may be spring connectors, pads or pins housed within a male or female connector.

The top plate 230 is configured to accommodate one or more antennas and optionally an identity module. As illustrated, the top plate 230 comprises a pair of micro antenna connectors 235a, 235b, which connect with removable mating antennas 240a and 240b, respectively. Alternatively, the antennas may be integrated into the top plate 230. In some embodiments, the antennas may be adjustable in orientation. As illustrated, the top plate 230 further comprises a micro SIM card slot 237, which becomes electrically coupled to the SIM connector component 219 when the top plate 230 is mounted.

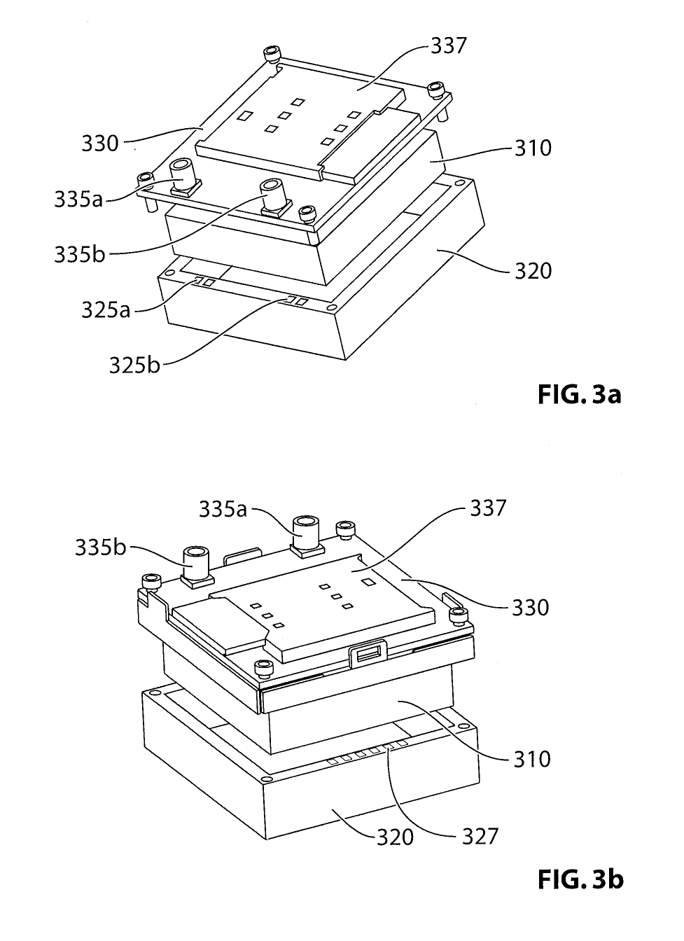

FIGS. 3a and 3b illustrate exploded perspective views of aspects of wireless communication modules provided in accordance with two alternative but similar embodiments of the present technology. A chip module 310 fits within a socket 320, and a top plate 330 is fitted to the socket. The top plate 330 comprises micro antenna connectors 335a and 335b, and a micro SIM card slot 337. Connection of the top plate to the socket may be, for example, via screws and corresponding apertures in the socket as illustrated in FIG. 3a, or via or clips as illustrated in FIG. 3b.

The socket 320 comprises electrical contacts 325a, 325b and/or 327 along a top edge for mating with corresponding contacts (not shown) on the underside of the top plate 330. Electrical conductors connected to the electrical contacts 325a, 325b and/or 327 are routed through the socket and coupled to appropriate socket connectors for connection with the chip module 310. In the case of contacts 325a and 325b, the electrical conductors may take the form of an RF transmission line.

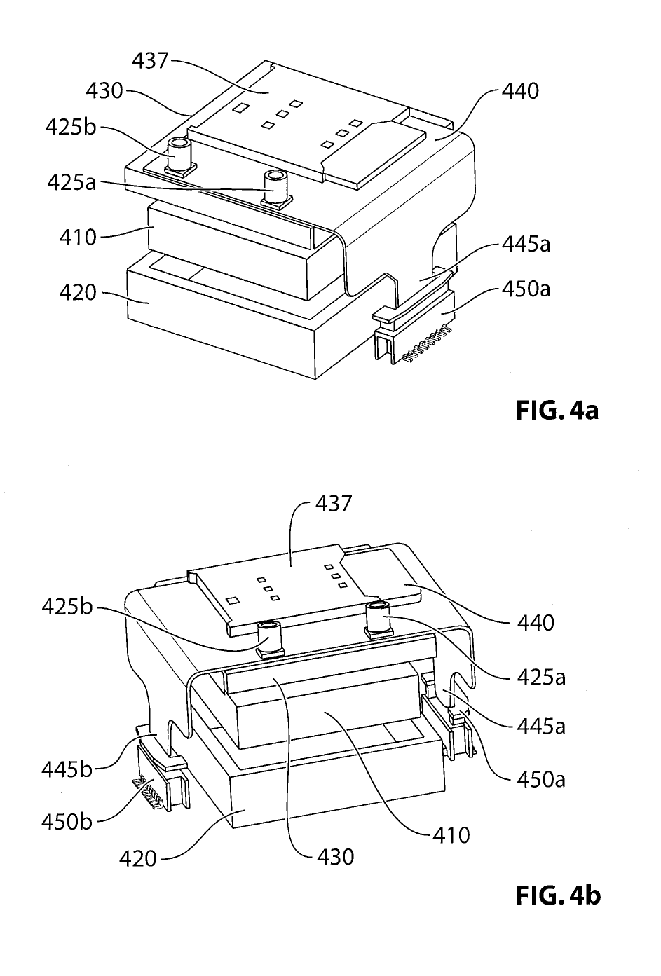

FIGS. 4a and 4b illustrate exploded perspective views of aspects of an alternative wireless communication module provided in accordance with embodiments of the present technology. A chip module 410 fits within a socket 420, and a top plate 430 is fitted to the socket. The top plate 430 comprises micro antenna connectors 435a and 435b, and a micro SIM card slot 437.

A flexible PCB 440 is affixed to the top plate, for example via an adhesive. The flexible PCB comprises electrical traces which are connected to the micro antenna connectors 425a and 425b and the micro SIM card slot 437, respectively for conveying signals to and/or from the chip module 410. The flexible PCB terminates at a plug-in electrical connector 445a which attaches to a corresponding plug-in electrical connector 450a, which is in turn electrically connected to appropriate socket connectors for connection with the chip module 410. FIG. 4b illustrates an optional second pair of plug-in electrical connectors 445b and 450b. The flexible PCB therefore wraps around the side edges of the module in order to connect to sockets of the base while also covering the top of the module.

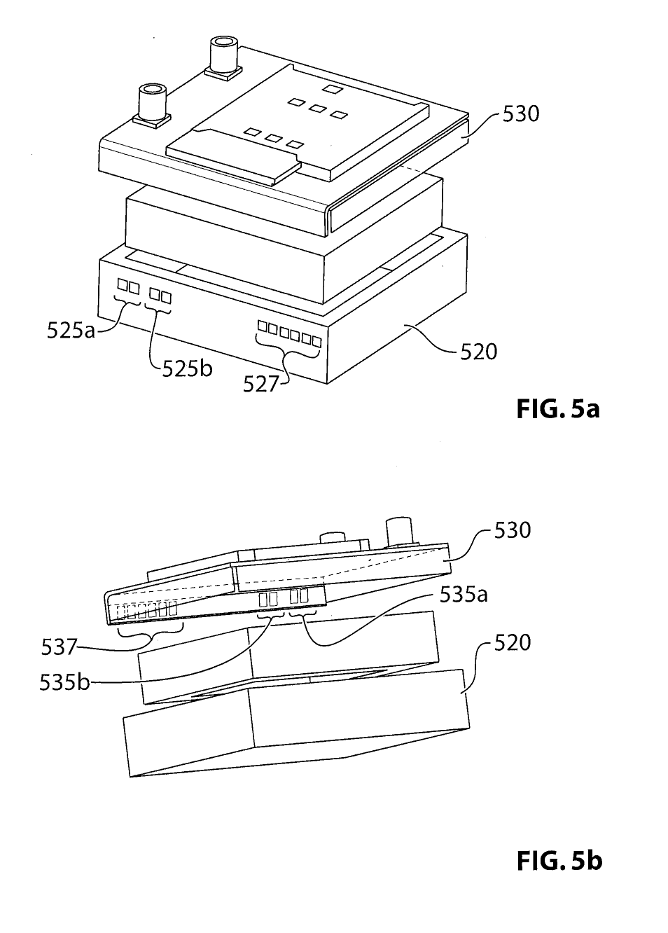

FIGS. 5a and 5b illustrate exploded perspective views of aspects of an alternative wireless communication module provided in accordance with embodiments of the present technology, which may be regarded as a variation of the module illustrated in FIGS. 3a and 3b. In particular, a socket 520 is provided which comprises electrical contacts 525a, 525b and 527 along aside outer edge for mating with corresponding contacts 535a, 535b and 537 on a facing inner side of a top plate 530.

### Example 4

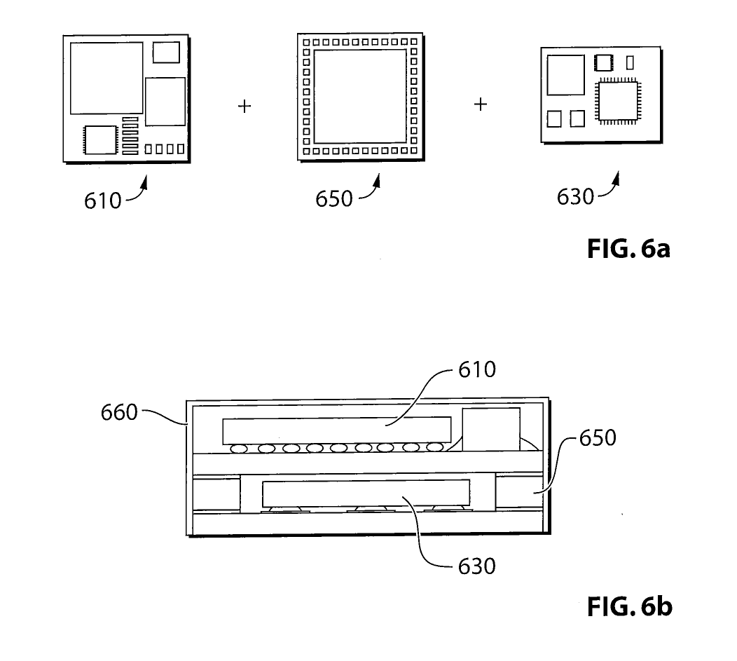

FIG. 6a illustrates three components which may be stacked together to provide for at least a portion of a wireless communication module in accordance with embodiments of the present technology. Each of the components may be compact PCAs, for example having a length of about 20 mm and a width of about 22 mm. An RF component 610 houses the RF electronics section, for example including a power amplifier section, radio frequency integrated circuit section, and the like. The RF component 610 may be configured to operate in accordance with one or more wireless protocols, such as GSM, UMTS, or LTE. A baseband component 630 houses the baseband electronics section, such as microcontrollers, volatile and/or non-volatile memory, baseband logic and electronics, identity modules, codecs, firmware, power management unit, and the like. A frame component 650 is provided for attachment to both the RF component 610 and the baseband component 630. The frame component 650 facilitates physical coupling of the other components 610 and 630. The frame component 650 comprises signal lines and connection points and facilitates operative coupling of the other components 610 and 630, for example via electrical connectors and signal lines.

In some embodiments, the frame component 650 comprises a cavity into which one of the RF component 610 and the baseband component 630 may be housed. In some embodiments, the cavity may further facilitate RF shielding of the housed component, for example the baseband component, by virtue of a conductive coating disposed on the frame component cavity or exterior. The frame component 650 may further comprise an outer area, for example surrounding the cavity, which comprises operative connection points for coupling between the RF component 610 and the baseband component 630.

In some embodiments, each of the RF components 610 may be selected from a first family of components, and the baseband components 630 may be selected from a second family of components, wherein each member of the first family is operable with each member of the second family. Thus, a wireless communication module having desired baseband and RF capabilities may be easily constructed by combining the appropriate component family members. Each family of components may comprise a substantially standardized interface, a substantially standardized interface protocol, a substantially standardized command set, substantially standardized power requirements, or a combination thereof.

In some embodiments, each member of each family of components may comprise a common layout of electrical connection points for corresponding connection with a single frame component layout. Alternatively, in some embodiments, a limited number of different frame boards may be provided for matching to different combinations of family members.

FIG. 6b illustrates, in cross section, a baseband component 630 housed within a frame component 650, and an RF component 610 stacked on top of the frame component 650. All three components are electrically connected via mating pads, pins, or other electrical connection means. In one embodiment, the entire stacked assembly may be about 3.8 mm to about 4 mm in height. In some embodiments, an encapsulant 660 is formed over the assembled components. Conductive vias may be formed through the encapsulant for operative connection of external antennas to the RF component 610, for operative connection of an external removable identity module plug-in connector to the baseband component 630, or both.

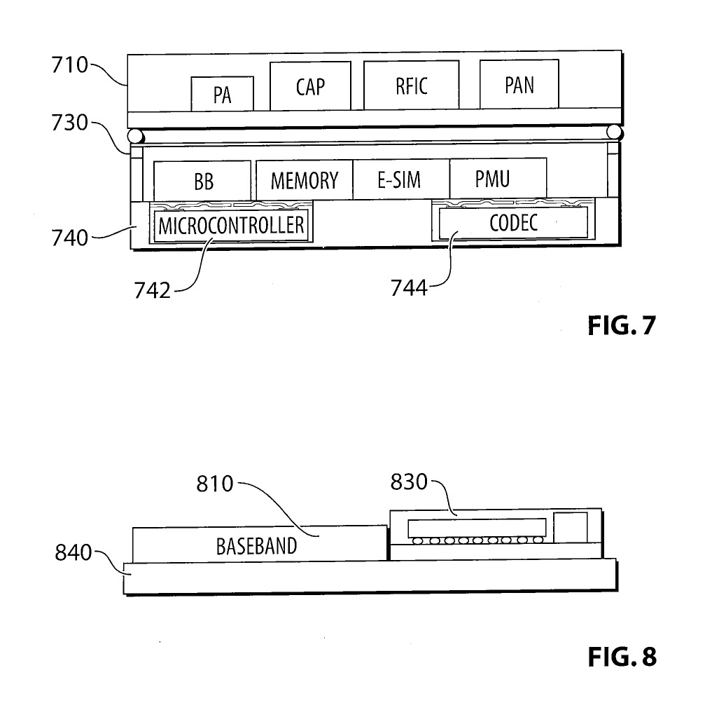

In some embodiments, the frame component or another supporting circuit board component may comprise functional components, such as a microcontroller or codec. For example, FIG. 7 illustrates an RF component 710 stacked with and coupled to a baseband component 730, which in turn is placed on top of a circuit board 740, which may form part of a frame component. The circuit board 740 comprises, for example embedded therein, a microcontroller 742 and a codec 744. A codec may comprise hardware such as a dedicated or shared microcontroller or microprocessor, possibly along with software or firmware instructions, configured for encoding and/or decoding a signal or data stream.

In some embodiments, rather than stacking of plural components, at least some of the components may be placed side by side. For example, FIG. 8 illustrates an RF component 830 and a baseband component 810, disposed side-adjacent and mounted on a host PCB 840. This may provide for a low profile option which may be desirable in some configurations. One or both of the RF component 830 and the baseband component 810 may comprise an encapsulating layer.

### Example 5

Embodiments of the present invention provide for stackable module components, such as stackable baseband and RF electronics section components. The stackability aspect can be beneficial for installation into size constrained places, such as cavities within host hand-held or mobile device products. By stacking modules, already existing surplus space inside a host product may be utilized, while also avoiding the need to modify components such as the motherboard in order to accommodate additional or different modules.

Some embodiments of the present invention provide for a printed circuit module (PCM) comprising a printed circuit board (PCB), with the PCM defining at least one cavity. The PCM is configured for coupling with at least one adjacent PCM in a stacked arrangement, for example by mating a non-cavity portion of the PCM with a corresponding portion of the adjacent PCM. At least one cavity defined by the PCM is configured to at least partially accommodate one or more electronic components. The electronic components either form part of the PCM or part of the adjacent PCM. Generally, the electronic components are mounted directly or indirectly on a PCB of the corresponding PCM.

In some embodiments, the PCM may be a printed circuit assembly, comprising one or more spacers mounted to a PCB thereof. The spacers generally act as extensions of the PCB, with at least some sidewalls of the spacers defining sidewalls of the PCM cavities. Tops of the spacers may comprise electrical connectors, such as pads, pins, solder balls, conductive apertures, or the like, which may be configured for operatively coupling to mating electrical connectors of an adjacent, stacked PCM. These electrical connectors may be electrically coupled to other elements of the PCM, for example PCB pads or traces.

In some embodiments, the spacers may comprise a frame formed around a perimeter of the PCB. The spacers or frames may be interposed between adjacent stacked PCBs, thereby providing increased space for accommodating components which may protrude from the PCB surface. The spacers or frames may be considered part of the PCA comprising the PCB to which they are attached. In some embodiments, such spacers or frames may be used in combination with cavities formed in the PCB surface as described below.

In some embodiments, plural stackable PCMs may be operatively interconnected by mating connectors. Connectors may be mounted on a non-cavity portion of a PCM, for example on a PCB surface or spacer surface. The connectors and, if applicable, spacers, may be configured to provide a predetermined distance between the PCBs of adjacent PCMs. Conductive traces may be routed overtop or through spacers to electrically connect connection points located at both ends of the spacers and thereby electrically connect the PCBs.

In some embodiments, plural stackable PCMs may be operatively interconnected by direct contact and soldering between the PCBs thereof. Surface traces of adjacent PCBs may be routed so as not to contact each other undesirably, or insulating material may be applied to portions of the otherwise contacting PCBs. For example, an insulating layer of predetermined thickness may be conformally applied to one or both PCB surfaces in appropriate regions.

FIG. 9 illustrates a PCM 920 stacked with an adjacent PCM 930. The PCM 920 comprises a cavity 922 with components 925 mounted therein. The PCM 930 comprises a cavity 932 with components 937 mounted therein. The two cavities 922 and 937 face and communicate with each other to form a contiguous cavity between the two stacked PCMs 920 and 930. As illustrated, at least some components 937 of the top PCM 930 are partially accommodated by the cavity 932 of the top PCM 930, and partially accommodated by the cavity 922 of the bottom PCM 920. Similarly or alternatively, at least some components 925 of the bottom PCM 920 are partially accommodated by the cavity 922 of the bottom PCM 920, and partially accommodated by the cavity 932 of the top PCM 930. By allowing components to be accommodated partially by the cavity of an adjacent PCM, cavities may be made shallower, and hence difficulties with mounting components within deep cavities may be reduced or avoided.

In various embodiments, the heights of the two cavities 922 and 937 may be varied. In some embodiments, one of the cavities may have a zero height, in which case the other cavity fully accommodates all of the components. In other embodiments, one or both cavities fully accommodates some or all of the components of the corresponding PCM.

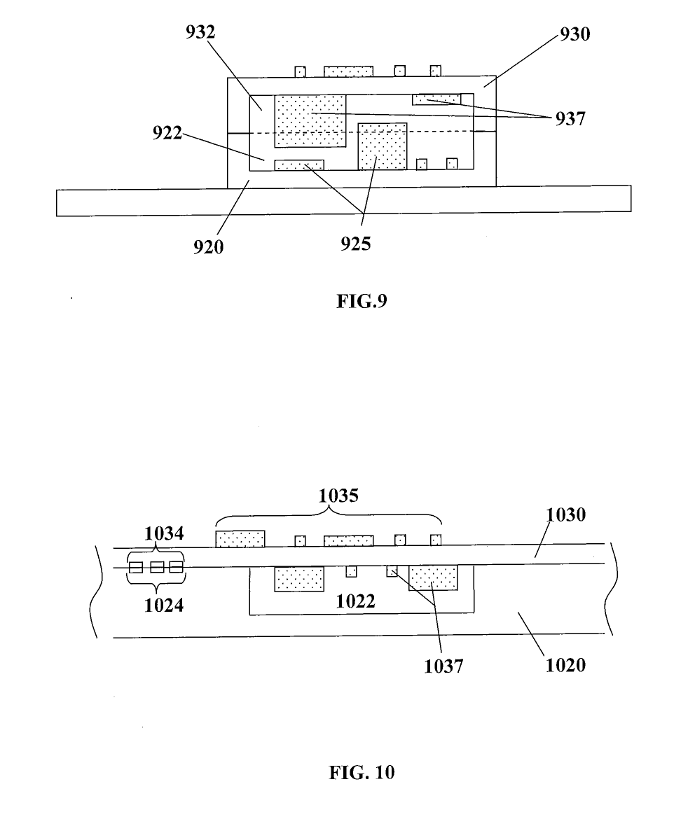

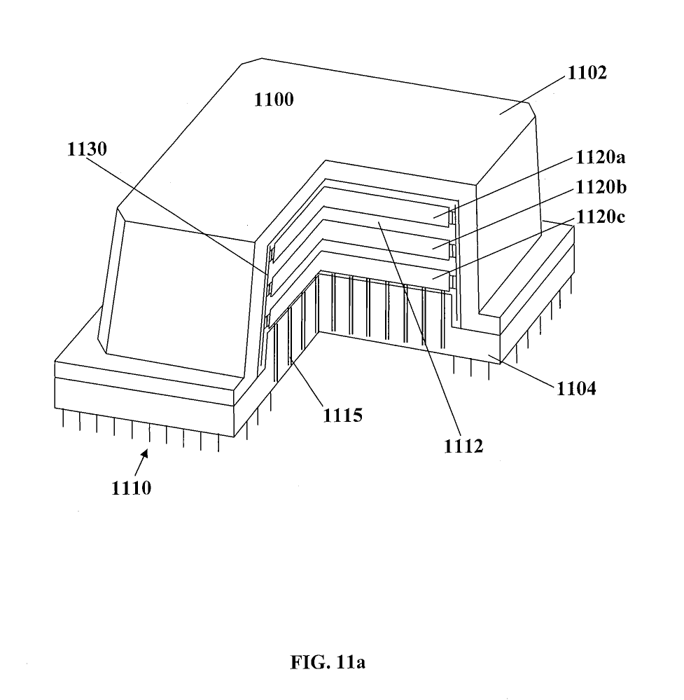

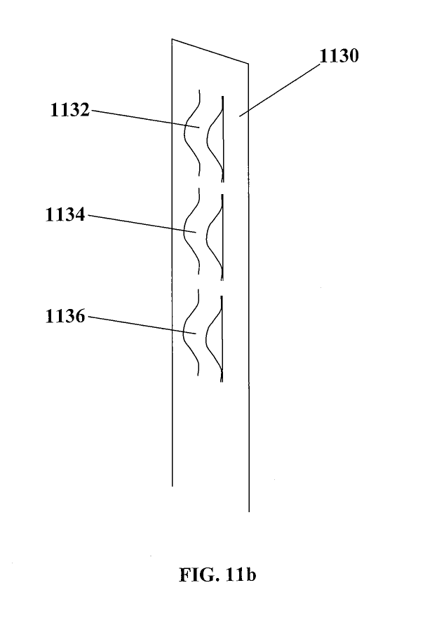

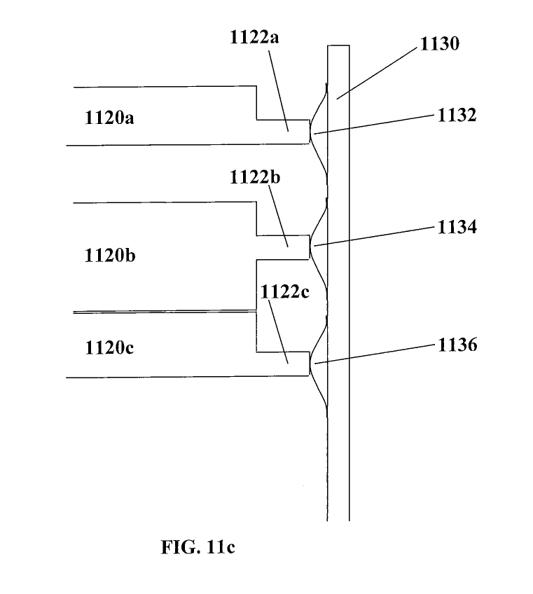

FIG. 10 illustrates a PCB 1020 having a cavity 1022 formed therein. The cavity 1022 may be formed by cutting into the PCB 1020, for example. The cavity may be cut through one or more layers of a multilayer PCB, and may be cut partway through a PCB insulating layer. The cavity may or may not terminate at a conductive interior layer of the PCB 1020. A PCB 1030 is coupled to the PCB 1020. The PCB 1020 may comprise electrical connectors 1024, such as pads, which mate with corresponding electrical connectors 1034 of the PCB 1030. The upper PCB 1030 comprises components 1037 mounted on a lower surface and accommodated within the cavity 1022 of the lower PCB 1020. The upper PCB 1030 may also comprise components 1035 mounted on an upper surface.

### Example 6

In accordance with an aspect of the present invention, there is provided a PCB-mountable socket for coupling electronics with a printed circuit board. The socket comprises a first set of electrical connectors configured for interfacing with the printed circuit board, for example pins, pogo pins, pads, solder balls, leads, grid arrays thereof, or the like mounted on the bottom of the socket. The socket further comprises a cavity configured to receive a plurality of electronics modules in a stacked configuration. The cavity comprises a second set of electrical connectors configured for interfacing with the plurality of electronics modules. For example, the second set of electrical connectors may be spring-type electrical connectors mounted in an array on the cavity sidewalls. At least one of the second set of electrical connectors is operatively coupled with at least one of the first set of electrical connectors.

In embodiments of the present invention, the electrical connectors mounted in the cavity comprise plural subsets of electrical connectors in a stacked configuration, each of the plural subsets configured for engaging corresponding electrical connectors formed around an edge of a respective one of the plurality of electronics modules. The electrical connectors may be resilient or spring-type connectors, which are configured to both electrically and grippingly engage the electronics modules. Various spring-type connectors, such as pogo pins, resilient bent metal contacts, and the like, as would be readily understood by a worker skilled in the art.

In accordance with a related aspect of the present invention, there is provided a modular electronics system comprising a socket and a plurality of electronics packages for housing in the socket in a stacked arrangement. Each of the plurality of electronics packages comprises electrical connectors formed around an edge thereof. Each of plural subsets of the socket electrical connectors is configured for operative engagement of the electrical connectors of a corresponding one of the plurality of electronics packages.

In embodiments of the present invention, the electronics modules are chips, such as chips housed in a leadless chip carrier such as a PLCC. The chips comprise conductive connectors, such as pins, pads, leads, or the like, arranged for example around the chip edge, and configured for coupling with a subset of the electrical connectors mounted on the socket cavity sidewalls.

In some embodiments, the electronics modules are printed circuit modules (PCMs), which are generally substantially smaller than the PCB onto which the socket is mounted. The PCMs may in some embodiments comprise cavities and/or encapsulating layers as described elsewhere herein. Such PCMs may comprise a plurality of traces or pads arranged in a predetermined pattern along the PCB edge, such that the these traces or pads contact and couple with a subset of the electrical connectors mounted on the socket cavity sidewalls.

Embodiments of the present invention may resemble a vertical stack of PLCC sockets. PLCC sockets are generally known in the art and comprise spring-type connectors for engaging edge connectors of a PLCC package. Each PLCC chip may be inserted and pushed down within the socket, thereby making room for insertion of an additional PLCC chip on top, until the socket is filled. This arrangement may facilitate densification of electronics, close coupling of electronics for improved integration, and the like.

FIG. 11a illustrates a socket 1100 for coupling to a printed circuit board (not shown) via electrical connectors 1110, such as pins, pads, solder balls, or the like. The socket 1100 comprises an enclosed cavity 1112 configured to receive stacked electronics modules 1120a, 1120b, 1120c, such as chips. Optionally, the socket 1100 comprises pins 1115, such as pogo pins, which may mate with a bottom module 1120c, the circuit board, or both. Electrical connectors, such as connectors 1130 are provided on sidewalls of the cavity 1112 in an array configuration. Each of a plurality of connectors is configured for mating engagement with a corresponding connector of an electronics module. The connectors of the socket 1100 may be spring-type connectors, for example. Each electronics modules comprises connectors, such as pins or pads, on sides thereof for such mating engagement. In some embodiments, electronics modules may be electrically connected substantially exclusively via the socket pins 1115 and/or sidewall connectors 1130. In some embodiments, electronics modules may additionally be directly electrically connected to each other via mating pads on adjacent and contacting surfaces thereof, for example.

As illustrated, the socket 1100 includes a cap portion 1102 and a base portion 1104. The cap portion 1102 and the base portion 1104 may be separated for assembly, at which time the electronics modules 1120a, 1120b, 1120c are fitted within the cap portion 1102. The cap portion 1102 may then be affixed to the base portion 1104 via adhesive, screws, snaps, or other connectors and the assembled socket affixed to a circuit board. Alternatively, an aperture (not shown) may be formed in the top or side of the cap portion 1102 for inserting electronics modules into the socket even when the cap portion and base portion are connected. The socket 1100 may be sealed after assembly to prevent tampering or unauthorized disassembly. Alternatively, in some embodiments the socket 1100 may be configured so that it may be re-opened after assembly and the modules serviced, replaced, or switched by a technician if desired. This may be useful during prototyping or early product life, for example.

FIG. 11b illustrates a portion of a stacked connector 1130 provided within the socket 1100. Plural such stacked connectors may be arranged side by side on one or more sidewalls of the cavity 1112 of the socket 1100. Each connector may be electrically coupled, via wires or traces within the socket housing, to the electrical connectors 1110, thereby facilitating coupling between the electronics modules and the printed circuit board. The stacked connector 1130 may be inserted into a slot along the edge of the socket interior, the slot having been provided for this purpose.

Each stacked connector portion 1130 comprises plural resilient spring-type connectors 1132, 1134, 1136, for example in the form of metallic protrusions. The connectors 1132, 1134, 1136 are configured for electrically and frictionally engaging corresponding connectors of the electronics modules when inserted into the cavity. The connectors may be electrically interconnected to each other via conductive material of the connector portion, or electrically isolated by use of non-conductive material between connectors.

FIG. 11c illustrates contact between pins 1122a, 1122b and 1122c and the connectors 1132, 1134, 1136 of the stacked connector portion 1130 illustrated in FIG. 11b. Each pin is a representative pin corresponding to a respective stacked electronics module 1120a, 1120b, 1120c. Each electronics module will typically have multiple pins, for example arranged in a plane as would be readily understood by a worker skilled in the art. In some embodiments, the stacked electronics modules 1120a, 1120b, 1120c are in close proximity or even in contact with each other. This arrangement is illustrated by the close proximity between modules 1120b and 1120c. By stacking the electronics modules in close proximity or in contact with each other, the assembly may be made resilient to mechanical shock which might otherwise tend to disconnect the pins from the spring connectors. An encapsulant may be formed over the modules to electrically isolate them from each other while also physically supporting each other. Assembly may also be simplified since each module is simply inserted as far as possible into the socket. If electronics modules are to be in close proximity and/or in contact, manufacturing of these modules may require tight control in order to provide modules of an appropriate thickness. In some embodiments, if a functional electronics module is not required at a certain level, a “dummy” spacer module may be inserted in its place. This may provide for a more mechanically resilient package, since the spacer modules may help to keep the other modules in place if the socket is subjected to mechanical shock.

In some embodiments, the pins 1122a, 1122b and 1122c engage and compress their respective resilient spring connectors 1132, 1134, 1136 in order to maintain adequate physical and electrical contact.

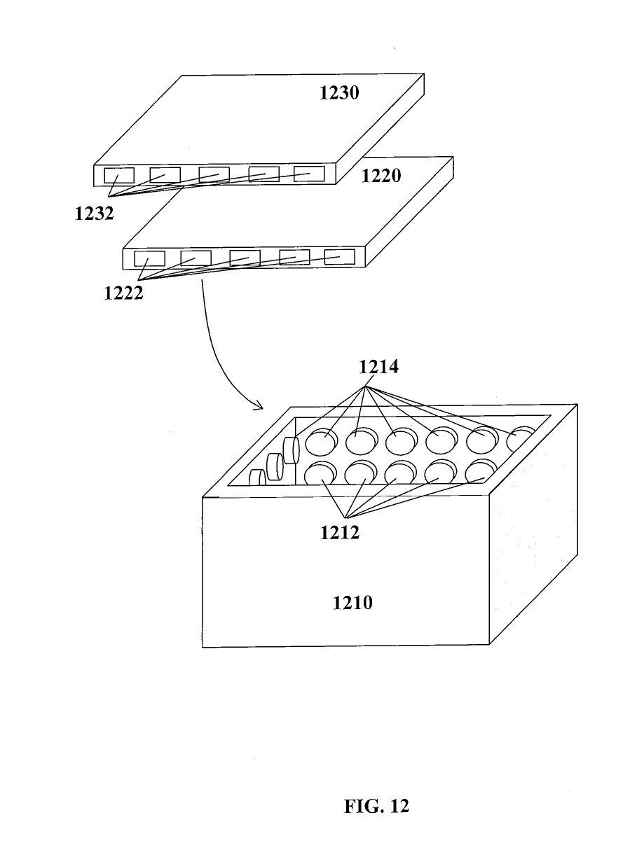

FIG. 12 illustrates a socket 1210 for coupling to a printed circuit board, and configured to receive stacked electronics modules 1220, 1230, therein, in accordance with another embodiment of the invention. The socket comprises at least a first subset of connectors 1212, such as pins or pads, configured to engage with corresponding electrical connectors 1222 of the electronics module 1220 when inserted in the socket generally at the height of the first subset. The socket further comprises at least a second subset of connectors 1214, such as pins or pads, configured to engage with corresponding electrical connectors 1232 of the electronics module 1230 when inserted in the socket generally at the height of the second subset. The socket 1210 comprises a top aperture through which electronics modules may be inserted. A cap may optionally be affixed over the top aperture after the electronics modules are inserted. The modules may optionally also be electrically connected directly to each other or to the socket via connectors on their top and/or bottom surfaces.

### Example 7

In accordance with an aspect of the present invention, there is provided a stackable, encapsulated printed circuit assembly (PCA) and/or set thereof. The PCA comprises a printed circuit board (PCB) with a first set of components mounted to the top side and a second set of one or more components mounted to the bottom side. An encapsulant is conformally provided over the PCB and the sets of components. One or more channels are formed through the encapsulant as described below. Each of the one or more channels is configured to operatively couple a predetermined interior location of the PCA with a predetermined location on a surface of the encapsulant. The predetermined interior location is associated with a conductor of the PCB or a mounted component.

In embodiments of the present invention, the channels through the encapsulant are conductive channels terminating with an electrical connector located at the encapsulant surface. Plural channels and their corresponding electrical connectors may be provided on plural surfaces of the encapsulant, for example top and bottom surfaces, thereby facilitating stackability of the encapsulated PCA with other PCAs, which may in turn be encapsulated. Stackability may be vertical, horizontal, or a combination thereof.

In accordance with embodiments of the present invention, there is provided a system of stackable, encapsulated PCB modules. Each module may comprise a PCB having components on one or both sides, and with an encapsulant formed around the PCB and components. The encapsulant is generally conformal to the PCB and components, and may provide one or more of: physical shielding, electrical insulation, and electromagnetic shielding. Electromagnetic shielding may be provided, for example, by embedding a conductive Faraday cage within or on the encapsulant, such that the conductive portions of the Faraday cage do not electrically interfere with the conductive vias. Generally, the encapsulant is used in providing PCB modules which are stackable.

In some embodiments, each conductive channel may be formed as follows. A via is formed in the encapsulant, for example by laser drilling, the via reaching to a predetermined location on the PCB or component thereof. A pad or other electrical connection exists at the predetermined location. A conductor is then provided which passes through the via from the predetermined location to the outer perimeter of the encapsulant. In some embodiments, the conductor is provided by coating the surface of the via with conductive material such as copper or solder, or by filling the via with conductive material, either molten or solid, such as a thin wire. A contact may then be formed at the end of each via for operative coupling to a circuit board or adjacent PCB module. In embodiments, the contact is a solder ball. In other embodiments, the contact may be a lead, pin, pad, aperture, or other electrical contact as would be readily understood by a worker skilled in the art. Deposition of a conductive material coating may be performed by one of a variety of suitable methods as would be readily understood by a worker skilled in the art.

In embodiments of the present invention, the encapsulant may be an insulating material such as a synthetic resin, which is capable of being applied to a mold in liquid form and solidifying into a desired shape, for example having flat surfaces to facilitate stackability. The encapsulant surface may additionally or alternatively be machined into a desired shape. Desirable encapsulant materials may have good dimensional stability over time and temperature. Suitable encapsulant materials would be readily understood by a worker skilled in the art. For example, materials used in making individual microchip packages.

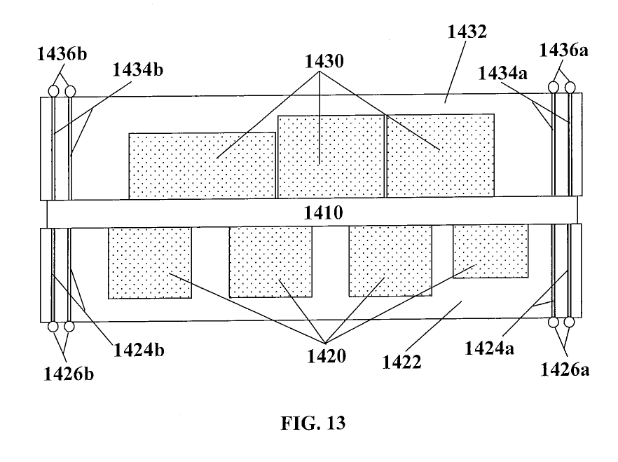

FIG. 13 illustrates, in cross section, a stackable, encapsulated printed circuit assembly (PCA) provided in accordance with another embodiment of the present invention. The PCA comprises a PCB 1410, upon which is mounted bottom side components 1420 and top side components 1430. An encapsulant 1422 is formed overtop of at least a bottom surface of the PCB 1410 and the bottom side components 1420. An encapsulant 1432 is also formed overtop of at least a top surface of the PCB 1410 and the top side components 1430. Encapsulant may also optionally be provided overtop of side edges of the PCB 1410. As illustrated, the encapsulant results in substantially flat, parallel top and bottom surfaces of the PCA.

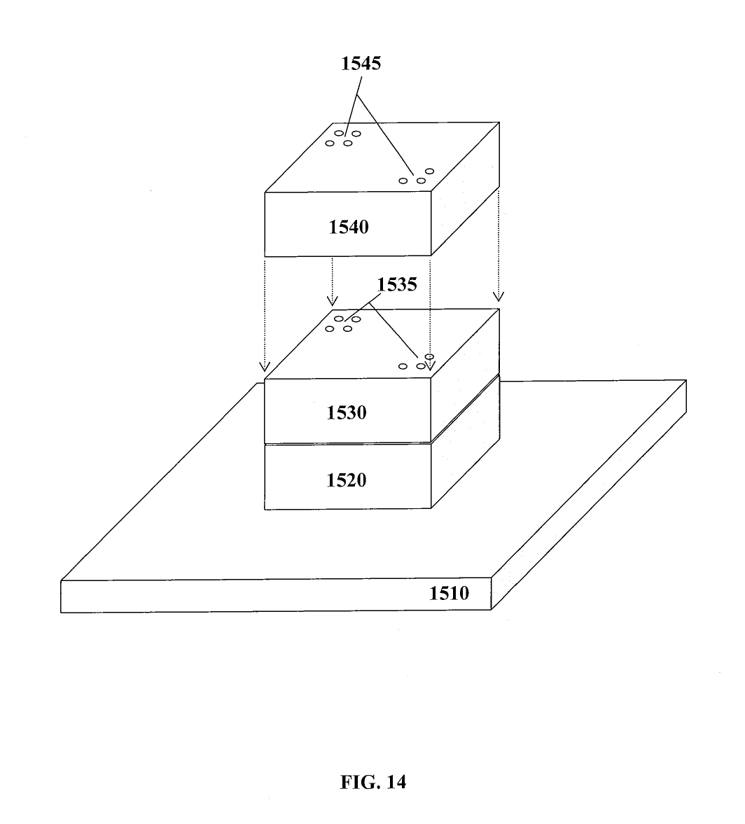

FIG. 13 further illustrates vias 1424a, 1424b, formed through the encapsulant 1422 and connecting with the bottom side of the PCB 1410, for example at pads or traces thereof. The vias comprise a conductor, such as a conductive coating formed on the sidewalls thereof. The vias are further electrically connected to connectors 1426a, 1426b, respectively, which may be solder balls, for example. FIG. 14 further illustrates vias 1434a, 1434b, formed through the encapsulant 1432 and connecting with the top side of the PCB 1410, for example at pads or traces thereof. The vias comprise a conductor, such as a conductive coating formed on the sidewalls thereof. The vias are further electrically connected to connectors 1436a, 1436b, respectively, which may be solder balls, for example. As illustrated in FIG. 14, the conductive vias 1424a, 1424b, 1434a, 1434b, and the connectors 1426a, 1426b, 1436a, 1436b, are formed on two opposing sides of the PCA. Such a PCA may be stacked in between two other PCAs.

FIG. 14 illustrates a host PCB 1510 upon which a stack of encapsulated PCAs 1520, 1530, 1540 are formed. Each encapsulated PCA comprises mating electrical connectors, for example connectors 1545 of PCA 1540 and connectors 1535 of PCA 1530, formed one or two encapsulant surfaces, such that adjacent encapsulated PCAs are electrically interconnected.

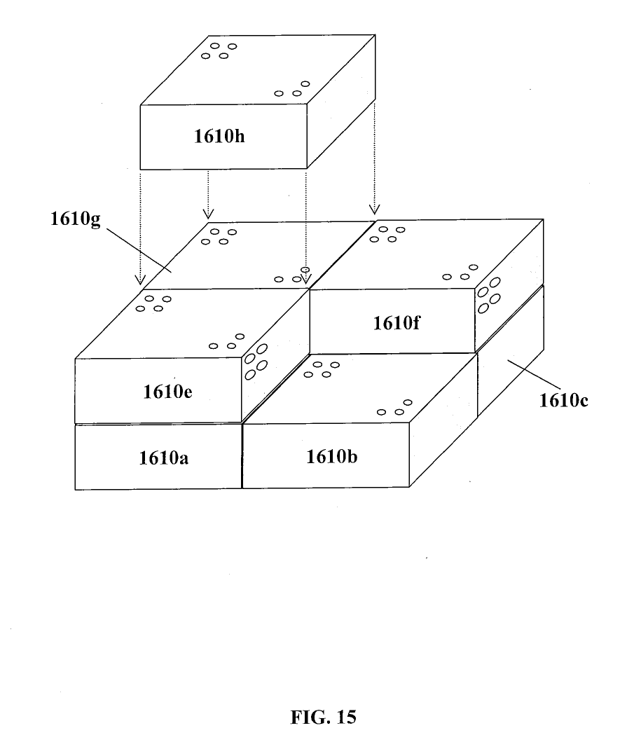

FIG. 15 illustrates a three-dimensional stack of encapsulated PCAs 1610a, 1610b, 1610c, 1610e, 1610f, 1610g, 1610h. Each encapsulated PCA comprises mating electrical connectors formed one or more encapsulant surfaces, such that adjacent encapsulated PCAs are electrically interconnected. Mating electrical connections may be formed on top, bottom, or side surfaces of the encapsulated PCAs.

The mating electrical connectors may be provided in a standardized pattern of locations, which is common between PCAs. Furthermore, each mating electrical connector location may correspond to a substantially standardized function, such as signal input, signal output, power, ground, generic, or the like. This facilitates modularity and interchangeability between PCAs.

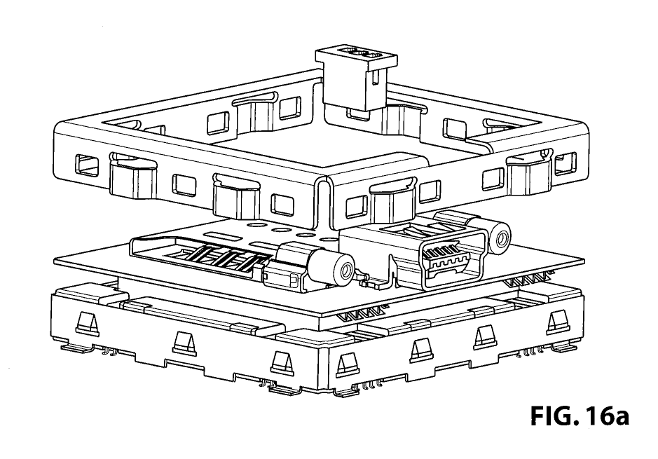

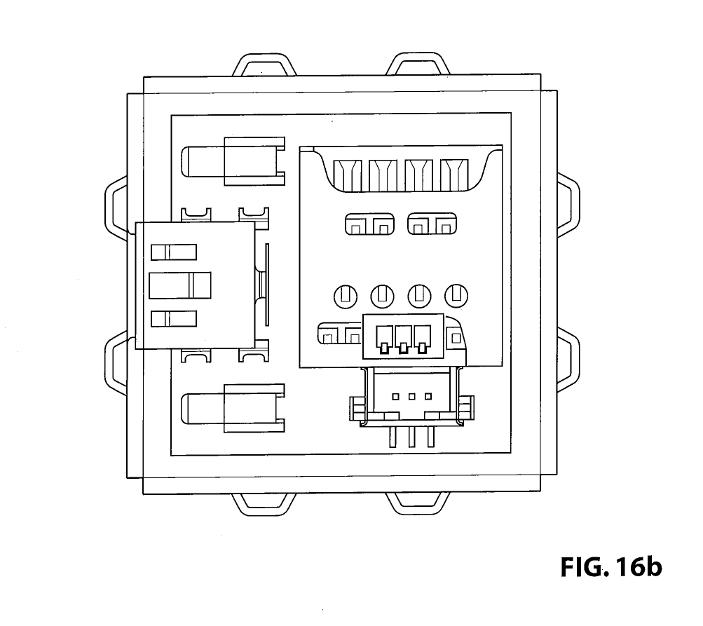

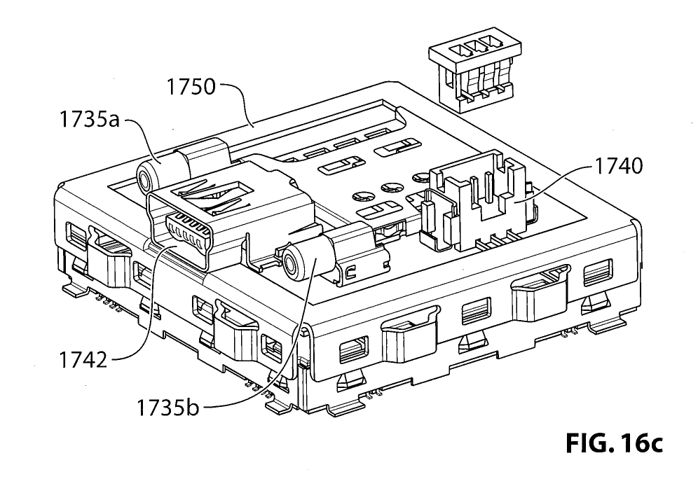

FIGS. 16a, 16b and 16c illustrate exploded, top and perspective views, respectively, of a wireless communication module provided in accordance with embodiments of the present technology. In particular, the module comprises a micro SIM card slot 1737, a pair of micro antenna connectors 1735a and 1735b, and another pair of power and/or signal connectors 1740 and 1742. The module may be provided within a socket and may comprise a functional electronics section. A metallic top cover 1750 is also shown, which snaps into place over the module. The power and/or signal connectors 1740 and 1742 may be used to operatively couple to other external power sources and/or electronics to facilitate operation, and may also optionally be used as connectors for test purposes.

It is obvious that the foregoing embodiments of the technology are examples and can be varied in many ways. The scope of the claims should not be limited by the specific embodiments set forth herein, but should be given the broadest interpretation consistent with the description as a whole, including all modifications as would be obvious to one skilled in the art.

What is claimed is:

1. An integrated wireless communication module configured to be coupled to a host device, the integrated wireless communication module comprising:
a) a data interface;
b) a baseband electronics portion operatively coupled to the data interface;
c) a radiofrequency electronics portion operatively coupled to the baseband electronics portion, the baseband electronics portion and the radiofrequency electronics portion facilitating operation of the wireless communication module as a wireless transmitter, receiver or transceiver in accordance with at least one wireless communication protocol; and
d) an antenna connector operatively coupled to the radiofrequency electronics portion;
wherein the integrated wireless communication module is configured to achieve certification as a stand-alone device with respect to one or more predetermined sets of certification criteria.

2. The wireless communication module according to claim 1, wherein the data interface comprises a plug-in connector.

3. The wireless communication module according to claim 1, wherein the baseband electronics portion comprises a removable identity module plug-in connector.

4. The wireless communication module according to claim 1, further comprising an antenna removably coupled to the antenna connector.

5. The wireless communication module according to claim 1, further comprising an alternative antenna connection point located at a base of the module and configured for soldering to a host printed circuit board.

6. The wireless communication module according to claim 5, further comprising a selectably electrically breakable internal connection operable to disable the alternative antenna connection point.

7. The wireless communication module according to claim 1, wherein the wireless communication module belongs to a family of interchangeable modules having different functionalities.

8. The wireless communication module according to claim 1, wherein two or more components of the module are provided in a stacked configuration.

9. The wireless communication module according to claim 1, wherein two or more components of the module are mounted side-by-side on a host circuit board, the two or more components further directly electrically connected via connection points on adjacent sidewalls thereof.

10. The wireless communication module according to claim 8, wherein at least one of the two or more components belong to a family of interchangeable components having different functionalities.

11. The wireless communication module according to claim 8, wherein at least one of the two or more components is located within a cavity of a printed circuit board or a frame component.

12. The wireless communication module according to claim 8, wherein at least two of the two or more components are stacked within a single socket.

13. The wireless communication module according to claim 8, further comprising a frame component onto which the two or more components are provided in the stacked configuration.

14. The wireless communication module according to claim 1, further comprising an encapsulant conformally provided over the module and one or more conductive channels formed through the encapsulant, the one or more conductive channels configured to operatively electrically couple an interior portion of the module to an exterior location.

15. The wireless communication module according to claim 14, wherein a further electrical connector is mounted at the exterior location and operatively coupled via the one or more conductive channels.

16. The wireless communication module according to claim 1, further comprising an encapsulant conformally provided over a component of the module and one or more conductive channels formed through the encapsulant, the one or more conductive channels configured to operatively electrically couple an interior portion of the component to a location exterior to the component.

17. The wireless communication module according to claim 1, further comprising a top plate having a substantially C-shaped cross section and configured to grippingly engage sides of the housing.

18. The wireless communication module according to claim 1, further comprising a socket configured for holding one or more chips, wherein the socket comprises one or more electrical conductors routed through an interior of the socket to an exterior sidewall or top portion, the one or more electrical conductors terminating at an electrical connector or contact.

19. The wireless communication module according to claim 1, further configured to achieve certification as a wireless module incorporated into a host device.

20. A method of manufacturing an integrated wireless communication module configured to be coupled to a host device, the method comprising:
a) providing a baseband electronics portion operatively coupled to a data interface;
b) providing a radiofrequency electronics portion operatively coupled to the baseband electronics portion, wherein the baseband electronics portion and the radiofrequency electronics portion facilitate operation of the wireless communication module as a wireless transmitter, receiver or transceiver in accordance with at least one wireless communication protocol;
c) providing an antenna connector operatively coupled to the radiofrequency electronics portion; and
d) configuring the integrated wireless communication module to achieve certification as a stand-alone device with respect to one or more predetermined sets of certification criteria.

21. The method according to claim 20, further comprising providing the baseband electronics portion and the radiofrequency electronics portion in a stacked configuration.

22. The method according to claim 20, further comprising selecting at least one of the baseband electronics portion and the radiofrequency electronics portion from a corresponding family of interchangeable components having different functionalities.

23. The method according to claim 20, further comprising providing at least one component of the wireless communication module within a cavity of a printed circuit board or a frame component.

24. The method according to claim 20, further comprising stacking at least two components of the wireless communication module within a single socket.

25. The method according to claim 20, further comprising providing a frame component onto which two or more components of the wireless communication module are provided in a stacked configuration.

26. The method according to claim 20, further comprising: conformally providing an encapsulant over the wireless communication module; and forming one or more conductive channels through the encapsulant, the one or more conductive channels configured to operatively electrically couple an interior portion of the module to an exterior location.

27. The method according to claim 20, further comprising: conformally providing an encapsulant over a component of the wireless communication module; and forming one or more conductive channels through the encapsulant, the one or more conductive channels configured to operatively electrically couple an interior portion of the component to a location exterior to the component.
